(19) United States
(12) Patent Application Publication
(10) Pub. No.: US 2025/0261055 A1
(43) Pub. Date: Aug. 14, 2025

(54) COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Hao WU, Dongguan (CN); Xin YOU, Dongguan (CN); Cong SHI, Dongguan (CN)

(21) Appl. No.: 19/196,883

(22) Filed: May 2, 2025

Related U.S. Application Data
(63) Continuation of application No. PCT/CN2022/130951, filed on Nov. 9, 2022.

(51) Int. Cl. H04W 36/00; H04W 36/30

(52) U.S. Cl. CPC H04W 36/0061; H04W 36/008375; H04W 36/30

(57) ABSTRACT

The present application provides a communication method and a communication device. The communication method comprises: on the basis of handover assistance information, a first communication device executes a first operation related to a handover, the communication device handover assistance information comprising first information and/or second information, wherein the communication device first communication device is located in a first area, the communication device first information comprises historical handover information corresponding to the first area of the communication device, and the communication device second information comprises information directly acquired by the communication device first communication device.

### CROSS-REFERENCE TO RELATED APPLICATIONS

This application is a continuation of International Application No. PCT/CN2022/130951, filed on Nov. 9, 2022, the disclosure of which is hereby incorporated by reference in its entirety.

### TECHNICAL FIELD

This application relates to the field of communications technologies, and more specifically, to a communication method and a communications device.

### RELATED ART

In related technologies, a handover process may be implemented based on information such as a measurement report and context information of a terminal device.

### SUMMARY

This application provides a communication method and a communications device. The following describes the aspects related to this application.

According to a first aspect, there is provided a communication method. The communication method includes: performing, by a first communications device based on handover assistance information, a handover-related first operation, where the handover assistance information includes first information and/or second information, where the first communications device is located in a first area, the first information includes historical handover information corresponding to the first area, and the second information includes information directly acquired by the first communications device.

According to a second aspect, there is provided a terminal device. The terminal device includes: a memory and a processor, where the memory is configured to store a computer program, and the processor is configured to execute the computer program stored in the memory to cause the terminal device to perform an operation of: performing a handover-related first operation based on handover assistance information, where the handover assistance information includes first information and/or second information, where the first communications device is located in a first area, the first information includes historical handover information corresponding to the first area, and the second information includes information directly acquired by the first communications device.

According to a third aspect, there is provided a network device. The network device includes: a memory and a processor, where the memory is configured to store a computer program, and the processor is configured to execute the computer program stored in the memory to cause the network device to perform operations including: receiving third information transmitted by a first communications device; and performing a handover-related second operation based on the third information, where the third information is determined based on handover assistance information, the handover assistance information includes first information and/or second information, the first communications device is located in a first area, the first information includes historical handover information corresponding to the first area, and the second information includes information directly acquired by the first communications device.

### BRIEF DESCRIPTION OF DRAWINGS

FIG. 1 is a schematic diagram of a wireless communications system to which embodiments of this application are applied.

FIG. 2 is an example diagram of a basic handover procedure.

FIG. 3 is an example diagram of a conditional handover procedure.

FIG. 4 is a schematic flowchart of a communication method according to an embodiment of this application.

FIG. 5 is a schematic flowchart of another communication method according to an embodiment of this application.

FIG. 6 is a schematic flowchart of still another communication method according to an embodiment of this application.

FIG. 7 is a schematic structural diagram of a communications device according to an embodiment of this application.

FIG. 8 is a schematic structural diagram of another communications device according to an embodiment of this application.

FIG. 9 is a schematic structural diagram of a communications apparatus according to an embodiment of this application.

### DESCRIPTION OF EMBODIMENTS

Technical solutions in this application are described below with reference to the accompanying drawings. To facilitate understanding, the following describes related terms in this application.

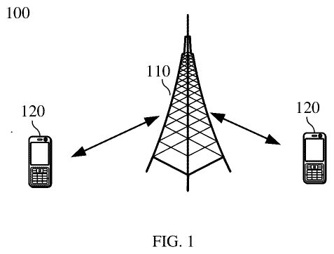

In the conventional technology, the information such as a measurement report and context information of a terminal device is “short-sighted” or difficulty in acquisition or storage, resulting in connection interruption and low throughput due to handovers. FIG. 1 shows a wireless communications system 100 to which embodiments of this application are applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 exemplarily shows one network device and two terminal devices. In some embodiments of this application, the wireless communications system 100 may include a plurality of network devices and another quantity of terminal devices may be included within coverage of each network device, which is not limited in the embodiments of this application.

In some embodiments of this application, the wireless communications system 100 may further include another network entity such as a network controller and a mobility management entity. This is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and an LTE time division duplex (TDD) system. The technical solutions provided in this application may be further applied to a future communications system, such as a 6th generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. In some embodiments of this application, the UE may function as a base station. For example, the UE may serve as a scheduling entity, which provides a sidelink signal between UEs in vehicle-to-everything (V2X), or device-to-device (D2D) communications, or the like. For example, a cellular phone and a vehicle communicate with each other by using a sidelink signal. A cellular phone and a smart home device communicate with each other, without the relay of a communication signal through a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover the following various names, or may be interchanged with the following names, such as a NodeB, an evolved NodeB (eNB), a next generation NodeB (gNB), a relay station, an access point, a transmitting and receiving point (TRP), a transmitting point (transmitting point, TP), a master eNodeB (MeNB), a secondary eNodeB (SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that assumes the function of a base station in D2D, V2X, and machine-to-machine (M2M) communications, a network-side device in a 6G network, a device that assumes the function of a base station in a future communications system, or the like. The base station may support networks of a same access technology or different access technologies. A specific technology and specific device used by the network device are not limited in embodiments of this application.

The base station may be stationary or mobile. For example, a helicopter or an unmanned aerial vehicle may be configured to function as a mobile base station, and one or more cells may move depending on a location of the mobile base station. In other examples, a helicopter or drone may be configured as a device for communicating with another base station.

In some deployments, the network device in this embodiment of this application may refer to a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. A scenario in which the network device and the terminal device are located is not limited in this embodiment of this application.

It should be understood that all or a part of functions of the communications device in this application may also be implemented by using a software function running on hardware or by using a virtualized function instantiated on a platform (for example, a cloud platform).

Many communications system may support a handover (handover HO) process. For example, both an LTE system and an NR system may support a handover process of a terminal device in connected state. The handover process may be a process in which the communications system transfers a communication link between the terminal device and a source cell to a new cell (also referred to as target cell). When a terminal device that is using a network service moves from one cell to another cell, or due to reasons such as adjustment of a load of a wireless transmission service, activation operation and maintenance, and a device fault, the communications system may execute a handover process to ensure continuity and quality of service of communication.

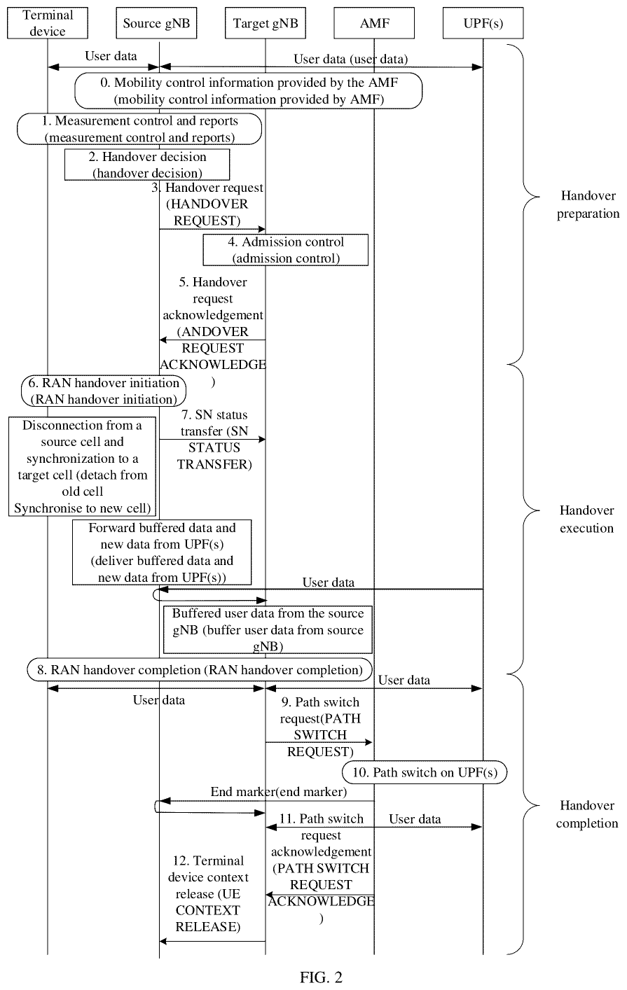

The following describes a basic handover procedure with reference to FIG. 2 by using an Xn interface handover process as an example. The handover process shown in FIG. 2 may include three stages: handover preparation, handover execution, and handover completion.

The handover preparation stage may include measurement control and reporting, and handover request and acknowledgment. A handover request acknowledgment message includes a handover command generated by a target cell. A source cell does not allow any modification of the handover command generated by the target cell, and directly forwards the handover command to a terminal device.

In the handover execution stage, the terminal device performs a handover process immediately upon receiving the handover command. That is, the terminal device performs the following operations: detaching from a source cell and connecting to a target cell (detach from old cell synchronise to new cell) (for example, performing random access, or transmitting a radio resource control (RRC) handover complete message to a target base station), sequence number (SN) state transition, data forwarding, and the like.

In the handover completion stage, the target cell performs a path switch with a core network access and mobility management function (AMF) and a user plane function (UPF), and context of the terminal device in the source base station is released.

The basic handover procedure is already functioning in the related wireless communications system, but some problems have gradually emerged. For example, in the basic handover procedure, the terminal device requires a time interval after reporting a measurement report and before receiving the handover command. During the time interval, the source cell transmits a handover request and waits for a response from a neighboring cell. In addition, this time interval also includes time for signalling exchange between the network device and the terminal device. Existence of this time interval may cause a change in an optimal configured cell when the terminal device receives the handover command. In extreme cases, existence of this time interval may result in that the terminal device is no longer suitable for connection (for example, the terminal device fails to receive the handover command due to poor communication conditions) when the network device transmits the handover command to the terminal device, leading to a handover failure.

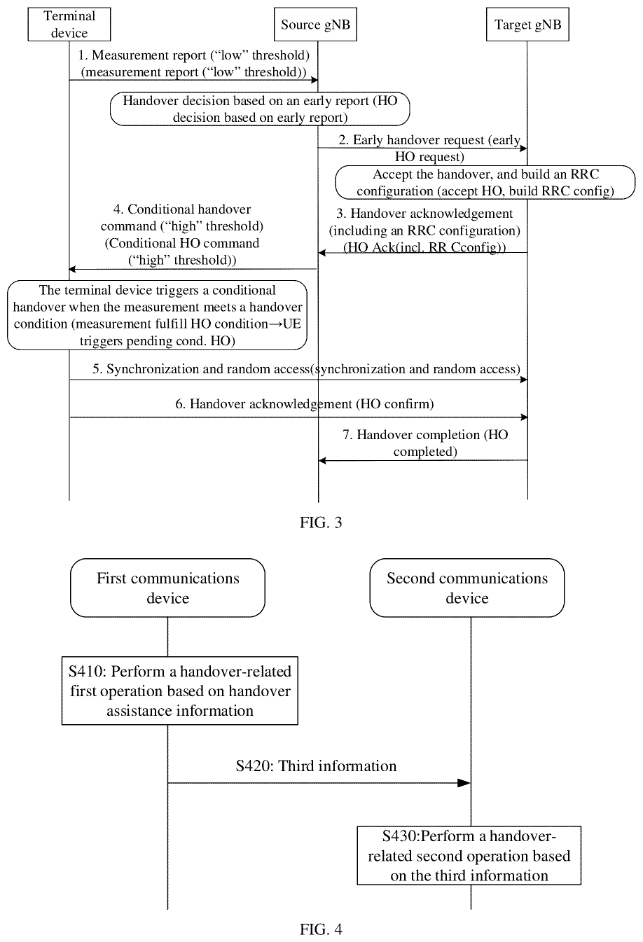

For some communications systems, solutions are provided to resolve the foregoing problems. For example, the 3rd generation partnership project (3GPP) has proposed a handover mechanism for conditional handovers in discussions. FIG. 3 is an example diagram of a conditional handover procedure. In a conditional handover, a first trigger condition and a second trigger condition are introduced. The first trigger condition triggers the terminal device to perform measurement reporting and accordingly triggers the base station side to prepare for a handover. The second trigger condition triggers the terminal device to initiate access to the target cell to complete the handover. The first trigger condition is weaker than the second trigger condition. As shown in FIG. 3, the first trigger condition may be related to a “low” threshold (“low” threshold), and the second trigger condition may be related to a “high” threshold (“high” threshold). In this case, the terminal device first meets the first trigger condition and triggers reporting of a corresponding measurement report, thereby triggering a handover preparation process. Then, when the terminal device meets the second trigger condition, the terminal device may initiate an operation such as accessing to the target base station to complete a handover process. It may be understood that, in a case in which the second handover condition is met, the terminal device may independently initiate a handover process without waiting for feedback from the network device side. Therefore, the conditional handover can avoid a time interval generated in the basic handover procedure, so as to avoid a handover failure.

It can be learned from the conditional handover procedure that, since several neighboring cells are required to reserve resources for an uncertain behavior of the terminal device to prepare for a potential handover, the neighboring cells may occupy far more resources compared with the basic handover procedure, resulting in affecting resource utilization and overall network performance of the entire system when network resources are limited (for example, during high load).

Compared with the existing wireless communications systems, the current wireless communications system offers greater flexibility, and implements broad applicability to different scenarios and efficient utilization of limited resources. However, the foundational working principles of most systems are still largely based on theoretical modeling of actual communication environments or simple parameter selection. The gain generated by this basic working approach gradually diminishes in varying scenarios and complex communication environments. This problem is involved in the basic handover and conditional handover solutions described above. In view of this, in some communications systems, the use of a new method and idea of artificial intelligence (AI) is being considered, which is combined with a conventional wireless communication theory and system, so as to further improve performance of the wireless communications system.

Artificial intelligence may be implemented by using a machine learning method. For example, a basic machine learning method may include supervised learning, unsupervised learning, or reinforcement learning.

Supervised learning may also be referred to as supervisory learning or supervised-style learning, involves learning or creating a model (also called a function or learning model) from training data, and then inferring a new instance by using the model. The training data is composed of an input object (typically vectors) and an expected output. The output may be a continuous value (known as regression analysis) or a predicted classification label (referred to as classification). A task of a supervised learner is to predict an output of a function for any possible input after observing some pre-labeled training examples (inputs and expected outputs). To achieve this purpose, the learner is required to generalize from existing data to obtain a result which cannot be directly observed in a “reasonable” (inductive bias) manner.

Reinforcement learning focuses on how to take actions based on an environment to maximize expected benefits. Reinforcement learning differs from supervised learning in: requiring no labelled input-output pairs, and sub-optimal solutions being unnecessary to be explicitly corrected. Instead, reinforcement learning focuses on finding a balance between exploration (of unknown field) and exploitation (of existing knowledge), and the exploration-exploitation trade-off in reinforcement learning has been most thoroughly studied through the multi-armed bandit problem and for finite state space Markov decision processes (MDP). For the MDP, in machine learning issues, an environment is typically abstracted as an MDP, and many reinforcement learning algorithms may use dynamic programming only under this assumption. A main difference between a conventional dynamic programming method and a reinforcement learning algorithm is that the latter does not assume knowledge of an MDP, and targets large MDPs where exact methods become infeasible.

As described in the foregoing basic handover procedure and conditional handover procedure, in a handover process of a related technology, the terminal device reports a measurement report based on a measurement result. The measurement report may be specifically reference signal received power. A basic handover procedure is used as an example. The network device may trigger a handover procedure upon receiving a measurement report. With reference to a network resource configuration situation, the network device determines a target cell from a plurality of neighboring cells. Then, the network device may transmit a handover command to the terminal device. Upon receiving the handover command, the terminal device may initiate random access to the target cell, to complete a handover procedure.

A decision to determine a target cell based on a measurement report is usually “short-sighted”, that is, after the terminal device successfully accesses the target cell, the terminal device may leave the cell within a very short period, causing a ping-pong effect, and thus reducing effective data transmission time and impairing throughput performance of the terminal device. For the network device, interaction signalling overheads are increased, and unnecessary network pre-configured resources are occupied.

In view of the foregoing problems, a possible solution is to predict a moving track of the terminal device before a handover, and determine a target cell for the handover based on the track. However, this solution requires accurate real-time location information of the terminal device during a moving process, and combination of the location information with a variety of contextual information such as historical movement data and behavior preferences of the terminal device. Acquiring and storing these information is extremely difficult for existing systems. Therefore, in related technologies, an optimal solution to trajectory prediction-based handover issues driven by individual user behavior is difficult to be provided.

It may be learned that, in related technologies, a handover process may be implemented based on information such as a measurement report and context information of a terminal device described above. However, the above information is “short-sighted” and difficulty in acquisition or storage, resulting in connection interruption and low network throughput due to handovers.

FIG. 4 is a schematic flowchart of a communication method according to an embodiment of this application, and the method is provided to resolve the foregoing problem. The method shown in FIG. 4 may be performed by a first communications device and/or a second communications device. The method shown in FIG. 4 may include step S410.

In step S410, the first communications device performs a handover-related first operation based on handover assistance information.

The handover assistance information may include first information and/or second information. The following describes the first information and the second information separately.

For the first information, the first communications device may be located in a first area, and the first information may include historical handover information corresponding to the first area. The historical handover information may be information related to a handover, for a first time window before a current instant. An end instant of the first time window may be earlier than or equal to the current instant. In some embodiments, the historical handover information may also be referred to as mobility context information.

Based on the first information, the first communications device may acquire area-level historical handover information. Based on the historical handover information corresponding to the first area, a performance gain achieved after the communication device is handed over to different neighboring cells can be predicted, thereby providing richer environmental information for a handover decision, that is, enhancing a capability of the first communications device to perceive the environment. Therefore, the historical handover information corresponding to the first area may resolve the foregoing problem of “short-sightedness”, thereby avoiding a ping-pong effect in handovers, and thus improving the throughput. According to studies, handovers based on the first information can achieve more than a 40% improvement in the system throughput. In addition, the first information is at an area level. Therefore, the first information may be stored in a device (for example, a network device covering the first area) that has a relatively strong calculation or storage capability in the first area, thereby reducing the difficulty in information acquisition and storage to some extent.

The second information may include information that can be directly acquired by the first communications device. In other words, the first communications device is not required to interact with another device, that is, the first communications device may independently acquire the second information. For example, the second information may be information that may be acquired without responding to reference signal configurations by the network device. In some embodiments, the first communications device may include a sensor. The second information may be information directly collected by the first communications device by using a sensor of the first communications device. Since the second information may be directly acquired by the first communications device, thereby simplifying acquisition of the second information. In addition, the second information may be acquired in real time. Therefore, a real-time status of the first communications device can be determined based on the second information, thereby implementing accurate handovers.

The following provides detailed examples of content that may be included in the first information and the second information.

As described above, the first information may be used to indicate historical handover information corresponding to the first area. The historical handover information may be information related to a handover, for a first time window before a current instant.

In an implementation, the historical handover information may include one or more of the following information: information about a handover cell selected by a third communications device; quality of service of the handover cell after the third communications device is handed over; or a quantity of times that a first cell covering the first area is selected as the handover cell. The third communications device may be a device that has performed communication in the first area. For example, the third communications device may be a communications device in the first area that is handed over before the first information is acquired by the first communications device. Alternatively, the third communications device may be a communications device that is handed over within a first time window before the current instant. It should be noted that the handover cell selected by the third communications device may also be referred to as a target cell selected by the third communications device. A quantity of times that the first cell is selected as the handover cell may be a quantity of times that the first cell is selected as a target cell in the first time window by the third communications device.

In an implementation, the historical handover information may include handover information of all terminal devices that have performed communication historically in the first area. For example, the historical handover information includes one or more of the following information: information about target cells selected by all the terminal devices; a quantity of times that the first cell covering the first area is selected by all the terminal devices historically; or quality of service of a target cell after all the terminal devices are handed over.

The quality of service of the target cell after the handover may include one or more of the following information: throughput, connection duration, or communication quality.

As described above, the first information may be related to the first area. The first area is an area in which the first communications device is located (for example, may include an area around the first communications device). The space may be divided into a plurality of handover prediction areas, and the first area may be one of the plurality of handover prediction areas. In other words, in the plurality of handover prediction areas, the area in which the first communications device is located may be the first area. The space is divided into a plurality of handover prediction areas, and the first information is associated with the first area in the plurality of handover prediction areas, so that a data size for storing the first information can be reduced.

The space may be divided into a plurality of handover prediction areas according to a first rule. The first rule may be, for example, related to received channel measurement information. In other words, a range of the first area may be determined based on received signal measurement information. In an implementation, the first area may be related to one or more cells to which at least one maximum signal that can be detected by the first communications device belongs. In an implementation, the first area may be related to cells to which n maximum signals that can be detected by the first communications device belong. The first area may either be a total area of areas covered by the cells to which the n signals belong or areas covered by all the cells to which the n signals belong. For example, a first handover prediction area may be an area covered by cells 1, 2, and 3 to which three maximum signals that can be detected by the first communications device belong. Alternatively, a second handover prediction area may be an area covered by cells 1, 2, and 4 jointly to which three maximum signals that can be detected by the first communications device belong. The first area may be one of the first handover prediction area or the second handover prediction area.

In some embodiments, the first information may be further used to indicate network load information. In other words, the first communications device may perform the handover-related first operation based on the network load information. For example, the first operation is a handover decision. The first communications device may independently make a handover decision based on the historical handover information corresponding to the first area and the network load information.

The second information may include one or more of the following information of the first communications device: quality information of a source cell, quality information of a neighboring cell, quality change information of a source cell, quality change information of a neighboring cell, location information, speed information, or direction information. The direction information may include moving direction information of the first communications device. For example, the direction information may include an azimuth of movement of the first communications device.

After acquiring the second information, the first communications device may independently perform the first operation based on the second information, without transmitting the second information to another device. The second information is difficult to be acquired by another device, so that privacy of the first communications device can be effectively protected. In addition, a data amount that is required to be transmitted by the first communications device is reduced. Furthermore, in a case in which the first communications device has a relatively strong capability (for example, the first communications device is a smart vehicle, and a device that communicates with the first communications device is an old device, which is not configured with sufficient computing power), it is more appropriate for the first communications device to independently perform the first operation.

In an implementation, the handover assistance information may include the second information. The first operation may include: independently determining, by the first communications device, a target cell based on the second information acquired in real time; and handing over, by the first communications device, to the target cell. In other words, the first communications device may independently determine the target cell by using the complete second information acquired in real time by the first communications device, and perform a handover based on a result of the independent decision.

In some embodiments, the handover assistance information may include not only the second information but also the first information. The first information may be transmitted by a second communications device to the first communications device. The first communications device may independently determine the target cell based on the second information acquired in real time and the first information.

In some embodiments, the first operation may include: determining, by the first communications device, third information based on the first information and/or the second information. The second information may be acquired in real time by the first communications device before determining the third information. In other words, the third information may be determined by the first communications device, based on the second information acquired in real time, before determining the third information.

In an implementation, at least one of the first information or the second information may be input into a first model, and an output of the first model may be the third information. For example, the first model is an AI model. The first communications device may input the first information and/or the second information into the AI model, and an output of the AI model may be the third information. The AI model may include, for example, a supervised learning model or a reinforcement learning model. For example, the AI model may include one or more of a decision tree model, a multi-armed bandit model, or a deep Q network (DQN) model.

The third information may include, for example, one or more of the following information of the first communications device: information about one or more candidate target cells that the first communications device is able to be handed over to; a priority of one or more neighboring cells; ranking of priorities of one or more neighboring cells; or T304 timer setting information of one or more neighboring cells. The one or more candidate target cells may include, for example, one or more neighboring cells or a plurality of cells associated with different future instants. One or more candidate target cells may form a list. In addition, the priority may be represented by a weight. The third information may further include a measurement report (for example, reference signal received power).

After the first communications device acquires the third information, the first operation may further include: transmitting the third information to the second communications device. As shown in FIG. 4, the method shown in FIG. 4 may include step S420 and step S430.

In step S420, the second communications device receives third information transmitted by the first communications device.

In step S430, the second communications device may perform a handover-related second operation based on the third information.

In some embodiments, the second operation may include: determining one or more of the following information based on the third information: a target cell that the first communications device is to be handed over to; or one or more candidate target cells that the first communications device is able to be handed over to. In other words, the second communications device may make a decision on a handover process of the first communications device.

An example in which the second operation includes determining, by the second communications device based on the third information, the target cell that the first communications device is to be handed over to is used for description. The third information may be determined based on the first information and the second information. The second communications device may determine fourth information based on the third information. The fourth information may be used to indicate the target cell that the first communications device is to be handed over to. The second communications device may generate the fourth information with reference to a real-time resource distribution status of the network (for example, a network topology status or a load migration status). The second communications device may transmit the fourth information to the first communications device, and the second communications device may further instruct a target base station to reserve an access resource for the first communications device. The second communications device may further generate a handover command, so as to instruct the first communications device to perform a subsequent handover procedure.

In some embodiments, the second operation may include: preparing communication resources for the first communications device based on the third information. For example, the third information includes information about a candidate target cell. The second communications device may prepare a resource for the first communications device based on the candidate target cell. For example, the second communications device is the network device, and the first communications device is the terminal device. In a conditional handover, the network device determines a candidate target cell. Generally, there is a relatively large quantity of candidate target cells, so as to ensure that the terminal device can access to the candidate target cell successfully. In this embodiment, since the candidate target cell is locally determined by the terminal device based on the first information and/or the second information, a quantity of candidate target cells is far less than a quantity of candidate target cells determined by the network device in the conditional handover. Therefore, resources prepared by the network device based on the third information are greatly reduced, thereby improving resource utilization and overall network performance.

In some embodiments, the second operation may include transmitting the first information corresponding to the third information. For example, the third information includes information about a candidate target cell. The first information corresponding to the third information may be used to indicate historical handover information of some or all of areas covered by the candidate target cell. In other words, the first area may be some or all of areas covered by the candidate target cell.

In some embodiments, the method shown in FIG. 3 may further include: receiving, by the first communications device, first information. In other words, the first information may be acquired by another device and transmitted to the first communications device.

The following uses an example in which a transmitter of the first information is the second communications device for description.

In an implementation, the first information may be carried in a broadcast message. A broadcast range of the broadcast message may be the first area. For example, the second communications device may broadcast the first information to all communications devices in the first area. In other words, a communications device that receives the broadcast message may be a communications device in the first area. The broadcast message may be, for example, a system information broadcast (SIB) message. The SIB message may include one or more of an SIB1 message, an SIB2 message, and an SIB3-SIB8 message. The first information is transmitted in a broadcast manner, thereby reducing a signalling transmission amount of the second communications device, and thus reducing processing complexity of the second communications device.

In an implementation, the first information may be carried in dedicated signalling. The dedicated signalling may be, for example, RRC dedicated signalling. For example, the first information may be carried in an RRC reconfiguration message. The second communications device may determine the first area based on a location of the first communications device, and transmit the corresponding first information to the first communications device in a directional manner. The location of the first communications device may be determined by using a positioning system, or may be determined based on received signal measurement information that is reported by the first communications device. In this manner, a size of the first information received by the first communications device can be reduced, and a data processing amount of the first communications device can be reduced.

It should be noted that the first information may be transmitted in a manner of combining broadcast with dedicated signalling, that is, the first information may be carried in a broadcast message and dedicated signalling. In some embodiments, part of the first information is transmitted in a broadcast manner, and the other part of the first information is transmitted in dedicated signalling. For example, in a case in which the first information includes the network load information, the network load information may be transmitted in a broadcast manner to reduce signalling overheads. The historical handover information may be transmitted in dedicated signalling to reduce a transmission data amount.

It should be noted that the first information may be transmitted in response to active request of the first communications device, or may be independently transmitted by the second communications device. For example, in a case in which the first information is transmitted by using a broadcast message, the second communications device may periodically transmit a broadcast message including the first information. Alternatively, in the conditional handover, in a case in which a first condition is met, the first communications device may transmit a request message to the second communications device, and the request message may be used to trigger the second communications device to transmit the first information.

As time elapses, the historical handover information corresponding to the first area is constantly changed, and therefore, the first information may be updated. The first information may be updated by a device that stores or maintains the first information. If storage or maintenance of the first information is performed by the second communications device, the first communications device may transmit, to the second communications device, information corresponding to a handover subjected by the first communications device, so that the second communications device updates the first information. In other words, the historical handover information for the first area may be determined based on information corresponding to a handover. Information corresponding to a handover may include one or more of the following information of the first communications device: an area or a specific location where the handover is performed; a target cell selected; or a quantity of times that a cell is selected and quality of service of the target cell after the handover.

The update of the first information may be periodic and/or triggered by an update message. In some embodiments, a periodic update may also be referred to as a static update. An update triggered by an update message may also be referred to as a dynamic update.

For a periodic update, a communications device that stores or maintains the first information may periodically update the first information according to a specific period. The first information that is periodically updated is described below using an example in which the first communications device is the terminal device and the second communications device is the network device. The terminal device may report, to the network device, information corresponding to handovers subjected by the terminal device during a period of time. The network device may summarize information reported by a plurality of terminal devices including the first communications device, and periodically update content of the first information stored or maintained by the network device. It may be understood that periodic updates can reduce signalling overheads.

In dynamic updates, all messages used to trigger the update of the first information may be update messages. For example, the update message may be a message used when the first communications device reports information corresponding to a handover. After receiving the update message, the communications device that stores or maintains the first information may update the first information. The example in which the first communications device is the terminal device and the second communications device is the network device is still used for description. After being handed over from a source base station to a target base station, the terminal device may report information corresponding to a handover subjected by the terminal device on the source base station. After receiving the reported information, the network device may update content of the first information. Dynamic updates may allow content in the first information to be updated more rapidly, thereby enhancing an environmental perception capability of devices using the first information.

In some embodiments, the update of the first information may be a combination of static updates and dynamic updates, that is, semi-static updates. For example, the first information is updated in a static manner in some areas, and the first information is updated in a dynamic manner in some areas. Update manners in some areas may be determined depending on service requirements of the areas. Alternatively, some communications devices may update the first information in a dynamic manner, and some communications devices may update the first information in a static manner. Update manners of some communications devices may be determined based on service types of the communications devices.

The update of the first information may be based on areas of different granularities. A granularity of areas for updates may be either at a first area level or at a sampling point level. For example, the first information may be updated at a granularity of the first area, that is, the second communications device may acquire, store, and update a load status of a network device with signal coverage in the first area and all of historical handover information for the first area. Alternatively, the first information may be updated at a granularity of a sampling point location, that is, the second communications device may acquire, store, and update a load status of a network device with signal coverage within a specific range around a sampling point and historical handover information for the range. A location of the sampling point may be preset. Alternatively, a granularity of areas for updates may include both the first area and a sampling point. In an implementation, the network load information may be updated at a granularity of the first area, and the historical handover information may be updated at a granularity of a sampling point location.

The first area may be covered by a plurality of cells, and the first information may be used to indicate historical handover information of all of areas in the plurality of cells, or may be used to indicate historical handover information of some of areas (that is, the first area is some or all of areas covered by some of cells in the plurality of cells). It may be understood that, in a case in which the first information is historical handover information of some of areas, a data size of the first information can be reduced. In a case in which the first information is required to be transmitted, data overheads for transmitting the first information are greatly reduced.

The some of areas may be determined based on second information acquired historically. The second information acquired historically may be used to determine third information. For example, the first communications device may acquire the second information locally, and determine the third information. Based on the third information, the first information corresponding to the third information may be determined. As described above, the third information may include information about a candidate target cell. The some of areas may be some or all of areas covered by the candidate target cell. In other words, the first information corresponding to the third information may include historical handover information for some or all of areas covered by the candidate target cell, that is, the first area is some or all of areas covered by the candidate target cell.

With reference to the foregoing description, according to the technical solution in which the first communications device may independently determine the target cell based on the second information acquired in real time, the first communications device may acquire the second information twice (second information acquired historically and second information acquired in real time), so as to implement a handover process. For example, the first communications device may acquire the second information (the second information acquired historically) once, and determine the third information based on the second information. The third information may include information about the candidate target cell. The first communications device may transmit the third information to the second communications device, and the second communications device may transmit, based on the third information, the first information corresponding to the third information. The first information corresponding to the third information may include only the historical handover information of the candidate target cell. The first communications device may acquire the second information (the second information acquired in real time) again, and determine the third information again based on the first information corresponding to the third information and the second information acquired in real time. The third information determined this time may be used for the first communications device to make a handover decision. For example, the third information may be used to indicate the target cell.

The second information acquired historically may be used to determine the third information (for example, a candidate cell list), and the second information acquired in real time may be used to further determine the target cell in combination with the first information. Since the third information has been reported previously, the second communications device has instructed the candidate target cell to reserve a resource. The first communications device may directly perform a handover operation based on an output result (target cell) of the first model, without reporting to the base station. For the two-step decision of the target cell, the UE can make a decision by using the real-time second information, thereby effectively resolving a problem of an information delay caused by interaction between the UE and the base station.

It should be noted that both the first communications device and the second communications device may be devices configured to implement communication. For example, the first communications device may be a network device or a terminal device, and the second communications device may be a network device or a terminal device. In an implementation, the first communications device and the second communications device may be a terminal device and a network device, respectively. In another implementation, both the first communications device and the second communications device may be terminal devices, that is, communication may be performed between the first communications device and the second communications device by using sidelink.

It should be noted that the embodiments provided in this application may be implemented in combination with a handover procedure in a related technology. For example, the embodiments provided in this application may be combined with a basic handover procedure, or may be combined with a conditional handover procedure.

The following describes this application in detail using Embodiment 1 and Embodiment 2.

### Embodiment 1

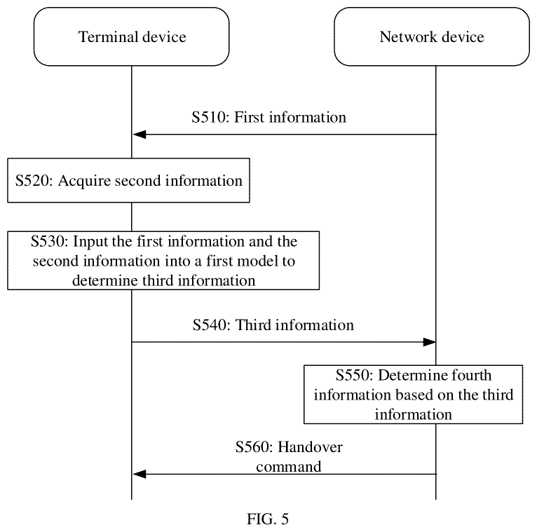

FIG. 5 is a schematic flowchart of a communication method according to Embodiment 1. In the method shown in FIG. 5, the first communications device may be a terminal device, and the second communications device may be a network device. The network device may be a source network device. The method shown in FIG. 5 may include steps S510 to S560.

In step S510, the network device transmits first information to the terminal device. The first information may include historical handover information corresponding to a first area.

In step S520, the terminal device independently acquires second information. The second information may include information that can be directly and independently acquired by the terminal device.

In step S530, the terminal device inputs the first information and the second information into a first model to determine third information. The first model may be an AI model. The third information may include a list of candidate target cells.

In step S540, the terminal device transmits the third information to the network device.

In step S550, the network device determines fourth information based on the third information. The fourth information may include information related to a target cell. Based on the fourth information, the network device may further instruct a target base station to reserve an access resource for the terminal device.

In step S560, the network device generates a handover command based on the fourth information. The handover command is used to instruct the terminal device to perform a subsequent handover procedure to be handed over to the target cell.

### Embodiment 2

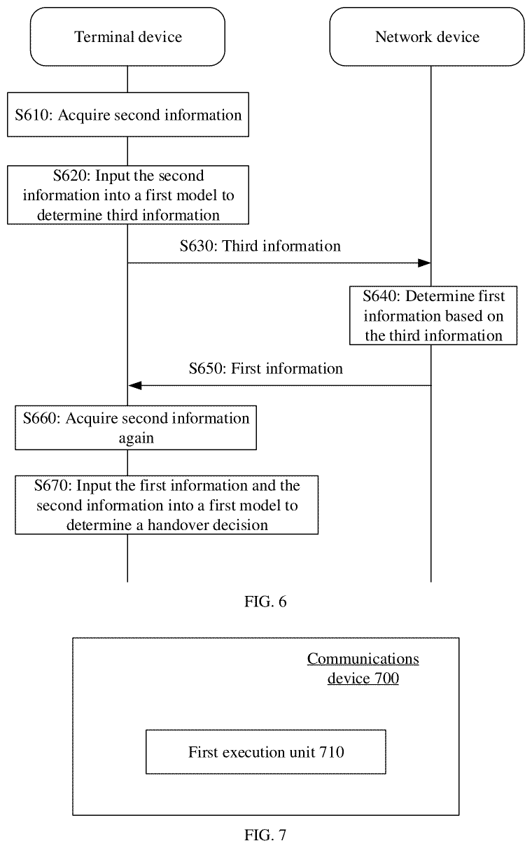

FIG. 6 is a schematic flowchart of a communication method according to Embodiment 2. In the method shown in FIG. 6, the first communications device may be a terminal device, and the second communications device may be a network device. The network device may be a source network device. The method shown in FIG. 6 may include steps S610 to S670.

In step S610, the terminal device acquires second information.

In step S620, the terminal device inputs the second information into a first model to determine third information. The third information may include a list of candidate target cells.

In step S630, the terminal device transmits the third information to the network device.

In step S640, the network device determines, based on the third information, first information corresponding to the third information. For example, the first information may include historical handover information for some or all of areas covered by the candidate target cell.

In step S650, the network device transmits, to the terminal device, first information corresponding to the third information.

In step S660, the terminal device acquires second information again. Compared with step S610, the second information acquired in step S660 may be understood as second information currently acquired in real time, and the second information acquired in step S610 may be understood as second information acquired historically.

In step S670, the terminal device inputs, into a first model, the second information acquired in step S660 and the first information acquired in step S650, to determine a handover decision. The terminal device may perform a subsequent handover process based on the handover decision independently determined by the terminal device.

The method embodiments of this application are described in detail above with reference to FIG. 1 to FIG. 6. Apparatus embodiments of this application are described in detail below with reference to FIG. 7 to FIG. 9. It should be understood that the descriptions of the method embodiments correspond to descriptions of the apparatus embodiments, and therefore, for parts that are not described in detail, reference may be made to the foregoing method embodiments.

FIG. 7 is a schematic structural diagram of a communications device 700 according to an embodiment of this application. The communications device 700 may be a first communications device. The communications device 700 may include a first execution unit 710.

The first execution unit 710 is configured to perform a handover-related first operation based on handover assistance information, where the handover assistance information includes first information and/or second information, where the first communications device is located in a first area, the first information includes historical handover information corresponding to the first area, and the second information includes information directly acquired by the first communications device.

In some embodiments of this application, the handover assistance information includes the second information, where the first operation includes: independently determining, by the first communications device, a target cell based on the second information acquired in real time; and handing over, by the first communications device, to the target cell.

In some embodiments of this application, the handover-related information further includes the first information, and the first information is transmitted by a second communications device to the first communications device. The process of independently determining, by the first communications device, the target cell based on the second information acquired in real time includes: independently determining, by the first communications device, the target cell based on the second information acquired in real time and the first information.

In some embodiments of this application, the first information is determined by the second communications device based on third information. The communications device further includes: a transmitting unit, configured to transmit the third information to the second communications device, where the third information is determined by the first communications device, based on the second information acquired in real time, before determining the third information.

In some embodiments of this application, the handover assistance information includes the first information and the second information. The first operation includes: transmitting, by the first communications device, third information to a second communications device, where the third information is determined by the first communications device based on the first information and the second information; and receiving, by the first communications device, fourth information transmitted by the second communications device, where the fourth information is used to indicate a target cell that the first communications device is to be handed over to.

In some embodiments of this application, the third information includes one or more of the following information of the first communications device: information about one or more candidate cells that the first communications device is able to be handed over to; a priority of one or more neighboring cells; ranking of priorities of one or more neighboring cells; or T304 timer setting information of one or more neighboring cells.

In some embodiments of this application, the first area is covered by a plurality of cells, and the first information includes historical handover information for some of areas in the plurality of cells.

In some embodiments of this application, the some of areas are determined based on second information acquired historically.

In some embodiments of this application, the first information further includes network load information.

In some embodiments of this application, the historical handover information includes one or more of the following information: information about a handover cell selected by a third communications device, where the third communications device is a communications device in the first area that is handed over before the first information is acquired by the first communications device; quality of service of the handover cell after the third communications device is handed over; or a quantity of times that a first cell covering the first area is selected as the handover cell.

In some embodiments of this application, the quality of service of the handover cell includes one or more of the following information: throughput, connection duration, or channel quality.

In some embodiments of this application, the second information includes one or more of the following information of the first communications device: quality information of a source cell, quality information of a neighboring cell, quality change information of a source cell, quality change information of a neighboring cell, location information, speed information, or direction information.

In some embodiments of this application, transmission of the first information is triggered by request information transmitted by the first communications device.

In some embodiments of this application, the first information is carried in a broadcast message and/or dedicated signalling.

In some embodiments of this application, the update of the first information is periodic and/or triggered by an update message.

In some embodiments of this application, a range of the first area is determined based on received signal measurement information.

In some embodiments of this application, the third information is determined by using an artificial intelligence AI model.

In some embodiments of this application, the AI model includes a supervised learning model or a reinforcement learning model.

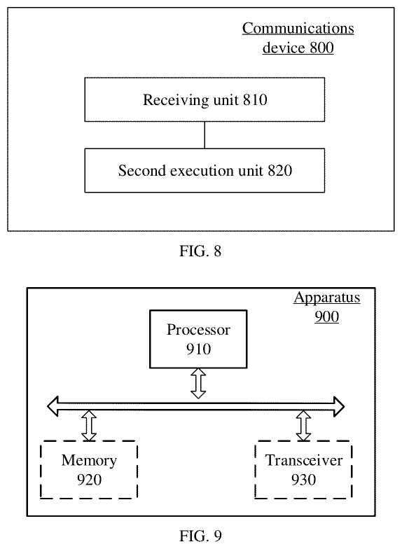

FIG. 8 is a schematic structural diagram of a communications device 800 according to an embodiment of this application. The communications device 800 may be a second communications device. The communications device 800 may include a receiving unit 810 and a second execution unit 820.

The receiving unit 810 is configured to receive third information transmitted by a first communications device. The second execution unit 820 is configured to perform a handover-related second operation based on the third information, where the third information is determined based on handover assistance information, the handover assistance information includes first information and/or second information, the first communications device is located in a first area, the first information includes historical handover information corresponding to the first area, and the second information includes information directly acquired by the first communications device.

In some embodiments of this application, the second operation includes: determining at least one of the following information based on the third information: a target cell that the first communications device is to be handed over to; or one or more candidate target cells that the first communications device is able to be handed over to.

In some embodiments of this application, the second operation includes: preparing communication resources for the first communications device based on the third information.

In some embodiments of this application, the third information includes one or more of the following information of the first communications device: information about one or more candidate target cells that the first communications device is able to be handed over to; a priority of one or more neighboring cells; ranking of priorities of one or more neighboring cells; or T304 timer setting information of one or more neighboring cells.

In some embodiments of this application, the first area is covered by a plurality of cells, and the first information includes historical handover information for some of areas in the plurality of cells.

In some embodiments of this application, the some of areas are determined based on second information acquired historically.

In some embodiments of this application, the first information further includes network load information.

In some embodiments of this application, the historical handover information includes one or more of the following information: information about a handover cell selected by a third communications device, where the third communications device is a communications device in the first area that is handed over before the first information is acquired by the first communications device; quality of service of the handover cell after the third communications device is handed over; or a quantity of times that a first cell covering the first area is selected as the handover cell.

In some embodiments of this application, the quality of service of the handover cell includes one or more of the following information: throughput, connection duration, or channel quality.

In some embodiments of this application, the second information includes one or more of the following information of the first communications device: quality information of a source cell, quality information of a neighboring cell, quality change information of a source cell, quality change information of a neighboring cell, location information, speed information, or direction information.

In some embodiments of this application, transmission of the first information is triggered by request information transmitted by the first communications device.

In some embodiments of this application, the first information is carried in a broadcast message and/or dedicated signalling.

In some embodiments of this application, the update of the first information is periodic and/or triggered by an update message.

In some embodiments of this application, a range of the first area is determined based on received signal measurement information.

In some embodiments of this application, the third information is determined by using an artificial intelligence AI model.

In some embodiments of this application, the AI model includes a supervised learning model or a reinforcement learning model.

In an optional embodiment, the transmitting unit or the receiving unit may be a transceiver 930, and the first execution unit 710 or the second execution unit 920 may be a processor 910. The communications device 700 or the communications device 800 may further include a memory 920, which is specifically shown in FIG. 9.

FIG. 9 is a schematic structural diagram of a communications apparatus according to an embodiment of this application. The dashed lines in FIG. 9 indicate that the unit or module is optional. The apparatus 900 may be configured to implement the method described in the foregoing method embodiments. The apparatus 900 may be a chip, a terminal device, or a network device.

The apparatus 900 may include one or more processors 910. The processor 910 may support the apparatus 900 to implement the method described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program, and the program may be executed by the processor 910, so that the processor 910 executes the method described in the foregoing method embodiments. The memory 920 may be independent of or integrated into the processor 910.

The apparatus 900 may further include a transceiver 930. The processor 910 may communicate with another device or chip through the transceiver 930. For example, the processor 910 may perform data transceiving with another device or chip by using the transceiver 930.

An embodiment of this application further provides a computer-readable storage medium, configured to store a program. The computer-readable storage medium may be applied to the terminal or the network device provided in embodiments of this application, and the program causes a computer to execute the methods performed by the terminal or the network device in various embodiments of this application.

An embodiment of this application further provides a computer program product. The computer program product includes a program. The computer program product may be applied to the terminal or the network device provided in the embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, and “fourth” in the specification, claims, and accompanying drawings of this application are used to distinguish between different objects, and are not used to describe a specific sequence. In addition, the terms “include” and “have” and any variations thereof are intended to cover the inclusion of non-exclusive.

In embodiments of this application, “indication” mentioned herein may refer to a direct indication, or may refer to an indirect indication, or may mean that there is an association relationship. For example, A indicates B, which may indicate that A directly indicates B, for example, B may be obtained by using A. Alternatively, it may indicate that A indirectly indicates B, for example, A indicates C, and B may be obtained by using C. It may further indicate that there is an association relationship between A and B.

In this embodiment of this application, “B corresponding to A” indicates that B is associated with A, and B may be determined according to A. However, it should be further understood that, determining B based on A does not mean determining B based only on A, but instead, B may be determined based on A and/or other information.

In this embodiment of this application, the term “correspondence” may indicate that there is a direct correspondence or an indirect correspondence between the two, or may indicate that there is an association relationship between the two, or may be a relationship of “indicating” and “being indicated”, “configuring” or “being configured”, or the like.

In this embodiment of this application, “predefined” or “pre-configuration” may be implemented by pre-storing corresponding code, tables, or other manners that may be used to indicate related information in a device (for example, including terminal device and network device), which is not limited in this application. For example, a pre-defining may indicate being defined in a protocol.

In this embodiment of this application, the “protocol” may refer to a standard protocol in the communications field, for example, may include an LTE protocol, an NR protocol, and a related protocol applied to a future communications system. This is not limited in this application.

In this embodiment of this application, the term “and/or” is merely an association relationship that describes an associated object, and indicates that three relationships may exist. For example, A and/or B may indicate that only A exists separately, both A and B exist, and only B exists. In addition, the character “/” in this specification generally indicates an “or” relationship between the associated objects.

In various embodiments of this application, a sequence number of the foregoing processes does not mean a sequence of execution. The execution sequence of the processes should be determined according to functions and internal logic of the processes, and should not constitute any limitation on an implementation process of the embodiments of this application.

In several embodiments provided in this application, it should be understood that the disclosed system, apparatus, and method may be implemented in another manner. For example, the described apparatus embodiment is merely an example. For example, the unit division is merely logical function division. In actual implementation, there may be another division manner. For example, multiple units or components may be combined or integrated into another system, or some features may be ignored or not performed. On the other hand, the displayed or discussed mutual coupling or direct coupling or communication connection may be through some interfaces, indirect coupling or communication connection of the apparatus or unit, and may be in an electrical, mechanical, or other form.

The units described as separate parts may or may not be physically separate, and parts displayed as units may or may not be physical units, may be located in one place, or may be distributed on multiple network units. Some or all of the units may be selected according to an actual requirement to implement the objectives of the solutions in this embodiment.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any available medium that can be read by a computer or a data storage device such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but are not intended to limit the protection scope of this application. Any change or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
performing, by a first communications device based on handover assistance information, a handover-related first operation, wherein the handover assistance information comprises first information and/or second information,
wherein the first communications device is located in a first area, the first information comprises historical handover information corresponding to the first area, and the second information comprises information directly acquired by the first communications device.

2. The method according to claim 1, wherein the handover assistance information comprises the second information,
wherein the first operation comprises:
independently determining, by the first communications device, a target cell based on the second information acquired in real time; and
handing over, by the first communications device, to the target cell.

3. The method according to claim 2, wherein the handover assistance information further comprises the first information, and the first information is transmitted by a second communications device to the first communications device,
wherein the independently determining, by the first communications device, the target cell based on the second information acquired in real time comprises:
independently determining, by the first communications device, the target cell based on the second information acquired in real time and the first information.

4. The method according to claim 3, wherein the first information is determined by the second communications device based on third information, wherein the method further comprises:
transmitting, by the first communications device, the third information to the second communications device, wherein the third information is determined by the first communications device, based on the second information acquired in real time, before determining the third information.

5. The method according to claim 1, wherein the handover assistance information comprises the first information and the second information,
wherein the first operation comprises:
transmitting, by the first communications device, third information to a second communications device, wherein the third information is determined by the first communications device based on the first information and the second information.

6. The method according to claim 4, wherein the third information comprises one or more of following information of the first communications device:
information about one or more candidate cells that the first communications device is capable of being handed over to;
a priority of one or more neighboring cells; or
ranking of priorities of one or more neighboring cells.

7. The method according to claim 1, wherein the first information further comprises network load information.

8. The method according to claim 1, wherein the historical handover information comprises one or more of following information:
information about a handover cell selected by a third communications device, wherein the third communications device is a communications device in the first area that is handed over before the first information is acquired by the first communications device;
quality of service of the handover cell after the third communications device is handed over; or
a quantity of times that a first cell covering the first area is selected as the handover cell.

9. The method according to claim 8, wherein the quality of service of the handover cell comprises one or more of following information: throughput, connection duration, or channel quality.

10. A network device, comprising a memory and a processor, wherein the memory is configured to store a computer program, and the processor is configured to execute the computer program stored in the memory to cause the network device to perform operations comprising:
receiving third information transmitted by a first communications device; and
performing a handover-related second operation based on the third information,
wherein the third information is determined based on handover assistance information, the handover assistance information comprises first information and/or second information, the first communications device is located in a first area, the first information comprises historical handover information corresponding to the first area, and the second information comprises information directly acquired by the first communications device.

11. The network device according to claim 10, wherein the third information comprises one or more of following information of the first communications device:
information about one or more candidate target cells that the first communications device is capable of being handed over to;
a priority of one or more neighboring cells; or
ranking of priorities of one or more neighboring cells.

12. The network device according to claim 10, wherein the historical handover information comprises one or more of following information:
information about a handover cell selected by a third communications device, wherein the third communications device is a communications device in the first area that is handed over before the first information is acquired by the first communications device;
quality of service of the handover cell after the third communications device is handed over; or
a quantity of times that a first cell covering the first area is selected as the handover cell.

13. A terminal device, comprising a memory and a processor, wherein the memory is configured to store a computer program, and the processor is configured to execute the computer program stored in the memory to cause the terminal device to perform an operation of:
performing a handover-related first operation based on handover assistance information, wherein the handover assistance information comprises first information and/or second information,
wherein a first communications device is located in a first area, the first information comprises historical handover information corresponding to the first area, and the second information comprises information directly acquired by the first communications device.

14. The terminal device according to claim 13, wherein the handover assistance information comprises the second information,
wherein the first operation comprises:
independently determining, by the first communications device, a target cell based on the second information acquired in real time; and
handing over, by the first communications device, to the target cell.

15. The terminal device according to claim 14, wherein the handover assistance information further comprises the first information, and the first information is transmitted by a second communications device to the first communications device,
wherein the independently determining, by the first communications device, the target cell based on the second information acquired in real time comprises:
independently determining, by the first communications device, the target cell based on the second information acquired in real time and the first information.

16. The terminal device according to claim 15, wherein the first information is determined by the second communications device based on third information, wherein the terminal device is further configured to:
transmit the third information to the second communications device, wherein the third information is determined by the first communications device, based on the second information acquired in real time, before determining the third information.

17. The terminal device according to claim 13, wherein the handover assistance information comprises the first information and the second information,
wherein the first operation comprises:
transmitting, by the first communications device, third information to a second communications device, wherein the third information is determined by the first communications device based on the first information and the second information.

18. The terminal device according to claim 16, wherein the third information comprises one or more of following information of the first communications device:
information about one or more candidate cells that the first communications device is capable of being handed over to;
a priority of one or more neighboring cells; or
ranking of priorities of one or more neighboring cells.

19. The terminal device according to claim 13, wherein the first information further comprises network load information.

20. The terminal device according to claim 13, wherein the historical handover information comprises one or more of following information:
information about a handover cell selected by a third communications device, wherein the third communications device is a communications device in the first area that is handed over before the first information is acquired by the first communications device;
quality of service of the handover cell after the third communications device is handed over; or
a quantity of times that a first cell covering the first area is selected as the handover cell.
